(19) United States
(12) Patent Application Publication
(10) Pub. No.: US 2018/0282035 A1
(43) Pub. Date: Oct. 4, 2018

(54) STORABLE FIXING BAND STRUCTURE

(71) Applicant: LOVETEX INDUSTRIAL CORP., Taipei (TW)

(72) Inventor: WEI-MING CHEN, Taipei (TW)

(21) Appl. No.: 15/830,048

(22) Filed: Dec. 4, 2017

(30) Foreign Application Priority Data
Mar. 31, 2017 (CN) 201720339452.1

(51) Int. Cl. B65D 63/10; F16B 1/00; F16B 2/08

(52) U.S. Cl. CPC B65D 63/1018; F16B 1/00; B65D 2563/107; F16B 2001/0028; F16B 2/08

(57) ABSTRACT

A storable fixing band structure having a retaining ring and a band body is provided. By a design of fixing areas of the band body, the mentioned storable fixing band structure can be perfectly stored without other tools when the storable fixing band structure is not in use.

### CROSS REFERENCE TO RELATED APPLICATIONS

This application claims the foreign priority to application CHINA 201720339452.1 (Mar. 31, 2017).

### BACKGROUND OF THE INVENTION

### 1. Field of the Invention

The present invention relates to a fixing band structure, in particular to a storable fixing band structure.

### 2. Description of the Prior Art

In daily life, fixation is required in many cases. The tools used for fixation is from ropes for binding to fixing bands using principles of sticking bands, sewing buttons, hook fasteners, etc. With people's requirements on convenience in use, various fixing bands have emerged accordingly.

In well-known arts and existing products, importance is always attached to convenience in “article fixing”, particularly how to quickly fix target articles. There is no related research and development on “non-use state” of fixing bands. As a result, the fixing bands are either placed randomly in a non-use period, or folded by giving play to individual smart thoughts of a user on site. For example, after randomly wound, a rope or other objects with similar functions are taken to bind the wound fixing bands. Even a bag is additionally needed to hold the un-used fixing bands. For user, not only inconvenience in storage but also poor aesthetics are caused. More severely, the fixing bands that are not well folded may cause inconvenience in use, such as knotting due to improper winding per se, etc., when in use next time.

In view of the above matters, developing a novel storable fixing band structure having the advantage of perfectly combines a storage design with the fixing band under a premise of having the convenience in use is still an important task for the industry.

### SUMMARY OF THE INVENTION

In light of the above background, in order to fulfill the requirements of the industry, the present invention provides a novel storable fixing band structure. The above storable fixing band structure not only can provide an effect of convenience in operation when the fixing band is used, but also has the advantage of convenience in storage when the fixing band is not in use.

One object of the present invention is to provide a storable fixing band structure to provide perfect storage when the storable fixing band structure is not in use through the design of fixing areas on a band body.

Another object of the present invention is to provide a storable fixing band structure to be stored spontaneously without other tools by means of the design of the fixing areas on a band body.

According to the foregoing objects, the present invention discloses a storable fixing band structure. The foregoing storable fixing band structure comprises a retaining ring, and a band body. The first end of the band body is fixed on the retaining ring. The first side of the band body comprises a first fixing area, and a second fixing area. The second side of the band body comprises a third fixing area. The first fixing area, the second fixing area, and the third fixing area are respectively selected from one of the followings: a hook surface of a sticking band, a loop surface of the sticking band, or a hook-loop combined surface of the sticking band. The second end of the band body can pass through the above retaining ring to form a ring shape with a proper size, such that the first fixing area is engaged with the second fixing area to play a role of the fixing band. When the above storable fixing band structure is about to be stored, the band body can be stored by inwards wound the first side surface of the band body with the retaining ring as a center and engaging the second fixing area with the third fixing area on the second side surface. Such that the second end of the wound band body can be stably fixed on the second side surface of the band body. In another preferable embodiment according to this present specification, the above second side may further comprise a fourth fixing area. The above fourth fixing area is close to the second end of the band body, and the fourth fixing area is selected from one of the followings: the hook surface of the sticking band, the loop surface of the sticking band or the hook-loop combined surface of the sticking band. When the above storable fixing band structure is about to be stored, the band body can be stored by inwards wound the second side of the band body with the retaining ring as a center and engaging the fourth fixing area with the first fixing area/the second fixing area. Such that the second end of the wound band body can be stably fixed on the first side of the band body.

### BRIEF DESCRIPTION OF THE DRAWINGS

FIG. 1 shows a schematic view of a storable fixing band structure of this invention;

FIG. 2 shows another schematic view of said storable fixing band structure of this invention;

FIG. 3 shows a schematic view of a storable fixing band structure of this invention when the storable fixing band structure is in used; and

FIG. 4 shows a schematic view of another storable fixing band structure of this invention.

### DESCRIPTION OF THE PREFERRED EMBODIMENTS

What probed into the invention is a storable fixing band structure. Detailed descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater details in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

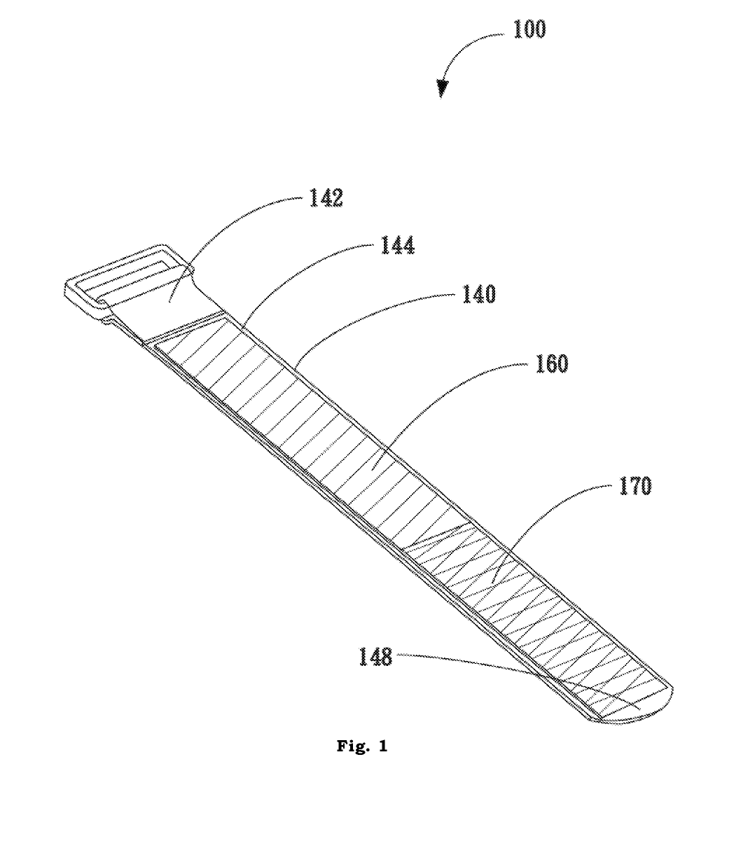

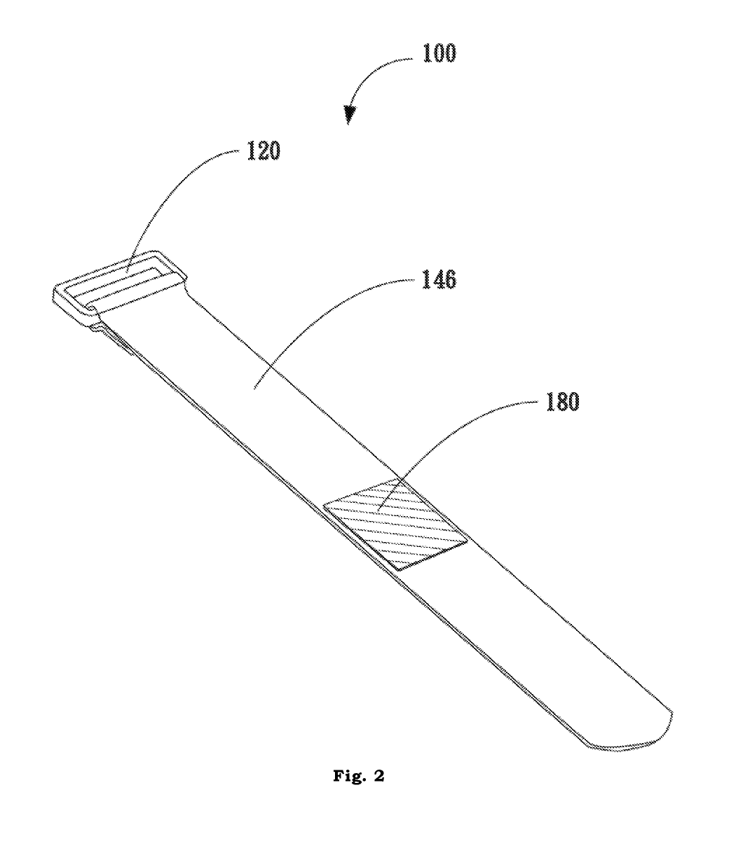

One embodiment according to this specification discloses a storable fixing band structure. FIGS. 1 to 3 are schematic views of a storable fixing band structure 100 of this embodiment. The above storable fixing band structure 100 comprises a retaining ring 120 and a band body 140. A first end 142 of the band body 140 is fixed onto the retaining ring 120. According to this present embodiment, a first side 144 of the band body 140 comprises a first fixing area 160 and a second fixing area 170, as shown in FIG. 1. A second side 146 of the band body 140 comprises a third fixing area 180, as shown in FIG. 2. The first fixing area 160, the second fixing area 170 and the third fixing area 180 can respectively be selected from one of the followings: a hook surface of a sticking band, a loop surface of the sticking band, or the hook-loop combined surface of the sticking band.

According to this present embodiment, a second end 148 of the band body 140 may pass through the retaining ring 120, and forms a ring shape of a proper size. The size of the above ring shape is adaptive to an object wanted to be fixed, and the second fixing area 170 is engaging with the first fixing area 160 to play a role of fixing the object wanted to be fixed.

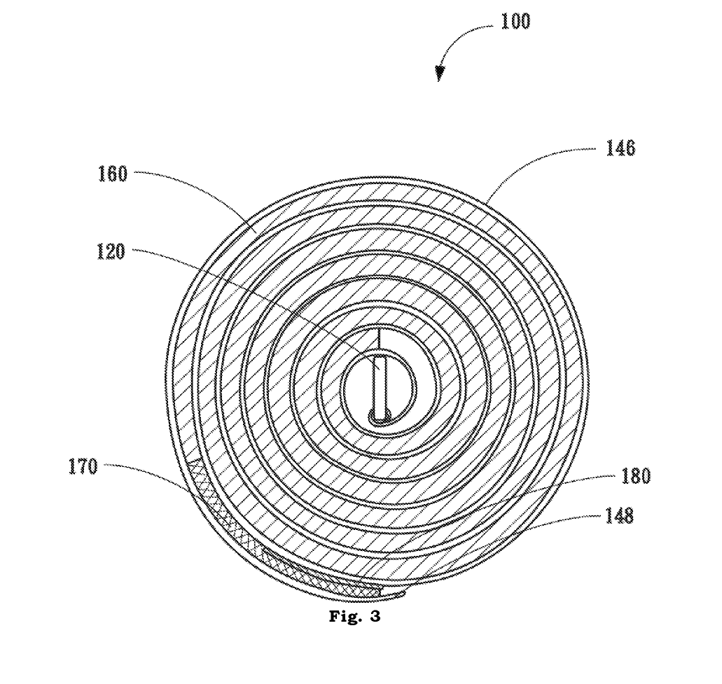

According to this present embodiment, when the storable fixing band structure 100 is about to be fixed, the band body 140 may be stored by inwards winding the first side surface 144 of the band body 140 with the retaining ring 120 as a center. At the end of winding, the second fixing area 170 may be engaged with the third fixing area 180 on the second side 146, such that the second end 148 of the wound band body 140 can be stably fixed onto the second side 146, as shown in FIG. 3. In this way, not only the above storable fixing band structure 100 is perfectly stored, but also the cases of inconvenience in use, such as improper winding or knotting, etc., of the band body 140 can be avoided when the storable fixing band structure 100 is used next time.

In a preferable example according to the present embodiment, the first fixing area 160 may be the loop surface of the sticking band, the second fixing area 170 may be the hook surface of the sticking band, and the third fixing area 180 may be the loop surface of the sticking band. In this way, the storable fixing band structure 100 according to the present embodiment not only can play a role of providing convenience in use of the fixing band, but also can have an effect of convenience in storage simultaneously.

In another preferable example according to the present embodiment, the first fixing area 160 may be the hook surface of the sticking band, the second fixing area 170 may be the loop surface of the sticking band, and the third fixing area 180 may be the hook surface of the sticking band. In this way, the storable fixing band structure 100 according to the present embodiment not only can play a role of providing convenience in use of the fixing band, but also can have an effect of convenience in storage simultaneously.

In yet another preferable example according to the present embodiment, the first fixing area 160 may be the loop surface of the sticking band, the second fixing area 170 may be the hook surface of the sticking band, and the third fixing area 180 may be the hook-loop combined surface of the sticking band. In this way, the storable fixing band structure 100 according to this present embodiment not only can play a role of providing convenience in use of the fixing band, but also can have an effect of convenience in storage simultaneously.

In still another preferable example according to the present embodiment, the first fixing area 160 may be the hook surface of a sticking band, the second fixing area 170 may be the loop surface of the sticking band, and the third fixing area 180 may be the hook-loop combined surface of the sticking band. In this way, the storable fixing band structure 100 according to the present embodiment not only can play a role of providing convenience in use of the fixing band, but also can have an effect of convenience in storage simultaneously.

In still another example according to the present embodiment, any one of the first fixing area 160, the second fixing area 170 and the third fixing area 180 may be the hook-loop combined surface of the sticking band, and the rest two may be respectively selected from one of the followings: the hook surface of the sticking band, the loop surface of the sticking band, and the hook-loop combined surface. In this way, the above storable fixing band structure 100 according to the present embodiment not only can play a role of providing convenience in use of the fixing band, but also can have an effect of convenience in storage simultaneously.

In still another example according to the present embodiment, the first fixing area 160, the second fixing area 170 and the third fixing area 180 are all the hook-loop combined surfaces of the sticking band. In this way, the above storable fixing band structure 100 according to the present embodiment not only can play a role of providing convenience in use of the fixing band, but also can have an effect of convenience in storage simultaneously.

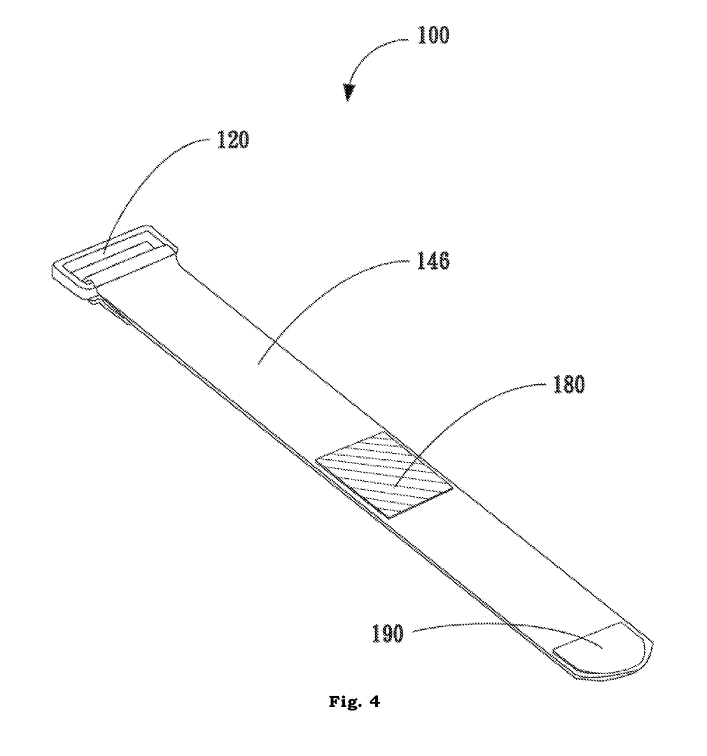

FIG. 4 is a schematic view of a storable fixing band structure of another preferable example according to the present embodiment. According to the present example, the storable fixing band structure 100 may further comprise a fourth fixing area 190. The fourth fixing area 190 is located on the second side surface 146 of the band body 140, as shown in FIG. 4. The fourth fixing area 190 is located on the second side surface 146 of the band body 140 and is close to the second end 148 of the band body 140. The fourth fixing area 190 may be selected from one of the followings: the hook surface of the sticking band, the loop surface of the sticking band or the hook-loop combined surface of the sticking band. According to this present example, the storable fixing band structure 100 may have two storage manners. The first manner is that the band body 140 is stored by inwards winding the first side 144 of the band body 140 with the retaining ring 120 as a center and engaging the second fixing area 170 with the third fixing area 180 on the second side 146, such that the second end 148 of the wound band body 140 can be stably fixed on the second side 146. The second manner of the storable fixing band structure 100 is that the band body 140 is stored by inwards winding the second side 146 of the band body 140 with the retaining ring 120 as a center and engaging the second fixing area 170 with the fourth fixing area 190 on the second side 146, such that the second end 148 of the wound band body 140 can be stably fixed on the second side 146.

In another practice according to this example, the storage manner of the storable fixing band structure 100 may also be that the band body 140 is stored by inwards winding the second side 146 of the band body 140 with the retaining ring 120 as a center and engaging the first fixing area 160 with the fourth fixing area 190 on the second side 146, such that the second end 148 of the wound band body 140 can be stably fixed on the second side 146.

In conclusion, the present specification discloses a storable fixing band structure. The storable fixing band structure comprises a retaining ring and a band body. The first end of the band body is fixed onto the retaining ring. The first side of the band body comprises a first fixing area, and a second fixing area. The second side of the band body comprises a third fixing area. The first fixing area, the second fixing area and the third fixing area can be respectively selected from one of the followings: the hook surface of the sticking band, the loop surface of the sticking band, or the hook-loop combined surface of the sticking band. When the storable fixing band structure is about to be stored, the band body can be stored by inwards winding the first side of the band body with the retaining ring as a center and engaging the second fixing area with the third fixing area on the second side, such that the second end of the wound band body can be stably fixed on the second side of the band body. According to this present specification, the storable fixing band structure can meet the requirements on convenience in use of the fixing band and the convenience in storage of the fixing band simultaneously without other tools by means of a structural design per se. What is better, since the storable fixing band structure according to the present specification can be perfectly stored when not in use, except for space saving in storage, the storable fixing band structure can avoid the cases, of proper winding or knotting, etc., of the band body when the storable fixing band structure is used next time.

What is claimed is:

1. A storable fixing band structure, characterized by comprising:
a retaining ring; and
a band body, wherein a first end of the band body is fixed on the retaining ring, wherein a first side of the band body comprises a first fixing area and a second fixing area, wherein a second side of the band body comprises a third fixing area, wherein the first side of the band body and the second side of the band body are located on opposite sides of the band body, wherein the first fixing area, the second fixing area are respectively selected from one of the followings: a hook surface of a sticking band, and a loop surface of the sticking band, wherein the third fixing area is selected from one of the followings: a hook surface of a sticking band, a loop surface of the sticking band or a hook-loop combined surface of the sticking band,
wherein while the storable fixing band structure used to fix an item, the second end of the band body can pass through the retaining ring to form a ring shape with a proper size, and the first fixing area is engaged with the second fixing area.

2. The storable fixing band structure according to claim 1, characterized in that when the first side of the band body is wound inwards with the retaining ring as a center, the second end of the band body is fixed by engaging said second fixing area with said third fixing area.

3. The storable fixing band structure according to claim 1, further comprising a fourth fixing area, wherein said fourth fixing area is located on a second side of the band body and is close to the second end of the band body, wherein the fourth fixing area is selected from one of the followings: the hook surface of the sticking band, the loop surface of the sticking band or the hook-loop combined surface of the sticking band.

4. The storable fixing band structure according to claim 3, characterized in that when the second side of the band body is wound inwards with the retaining ring as a center, the second end of the above band body is fixed by engaging said fourth fixing area with said second fixing area.

5. The storable fixing band structure according to claim 3, characterized in that when the second side of the band body is wound inwards with the retaining ring as a center, the second end of the band body is fixed by engaging said fourth fixing area with said first fixing area.
